(19) United States
(12) Patent Application Publication
(10) Pub. No.: US 2004/0245167 A1
(43) Pub. Date: Dec. 9, 2004

(54) Filtration apparatus

(76) Inventor: Gerhard Schmidt, Alberta (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/488,702

(22) PCT Filed: Sep. 5, 2001
(86) PCT No.: PCT/CA01/01253

(51) Int. Cl. B01D 27/00

(52) U.S. Cl. 210/445

(57) ABSTRACT

An improvement in a type of filtration apparatus which includes a housing having an inlet, an outlet, and a filter disposed between the inlet and the outlet so that fluids must flow through the filter in order to pass from the inlet to the outlet. The improvement is characterized by a first housing section with first peripheral edge and a second housing section with a second peripheral edge. One of the first peripheral edge of the first housing section or the second peripheral edge of the second housing section has a filter retaining groove. One of a rigid planar filter or a perforate rigid planar support adapted to support a filter membrane is disposed in the filter retaining groove. The first housing section and the second housing section are clamped together during use.

### FIELD OF THE INVENTION

The present invention relates to a filtration apparatus and, in particular, a filtration apparatus suitable for in line filtration of fluids flowing through a flow line.

### BACKGROUND OF THE INVENTION

Since at least as early as 1908 (U.S. Pat. No. 887,069 Cotter 1908) filtration apparatus have been disclosed which include a housing having an inlet, an outlet, and a filter disposed between the inlet and the outlet so that fluids must flow through the filter in order to pass from the inlet to the outlet. Variations of such filtration apparatus have been patented through the years: U.S. Pat. No. 1,917,121 Hughson 1933; U.S. Pat. No. 2,077,999 Hurn 1937; U.S. Pat. No. 2,773,601 Keller et al 1956; U.S. Pat. No. 3,267,193 Havelka 1966; and U.S. Pat. No. 5,340,478 Strand et al 1994.

### SUMMARY OF THE INVENTION

The present invention relates to a novel and inventive construction of filtration apparatus.

According to the present invention there is provided an improvement in the type of filtration apparatus which includes a housing having an inlet, an outlet, and a filter disposed between the inlet and the outlet so that fluids must flow through the filter in order to pass from the inlet to the outlet. The improvement is characterized by a first housing section with first peripheral edge and a second housing section with a second peripheral edge. One of the first peripheral edge of the first housing section or the second peripheral edge of the second housing section has a filter retaining groove. One of a rigid planar filter or a perforate rigid planar support adapted to support a filter membrane is disposed in the filter retaining groove. Means is provided for clamping the first housing section and the second housing section together.

The filtration apparatus, as described, provides a construction which is both simple and effective. Although beneficial results may be obtained through the use of this basic construction, further features may be added for even more beneficial results.

Even more beneficial results may be obtained when a clean out opening is provided. This clean out opening provides a means for removing from the housing particulate matter unable to pass through the filter.

Even more beneficial results may be obtained when the inlet and the outlet are both positioned in the first housing section with a baffle positioned between the inlet and the outlet to prevent fluids from flowing directly from the inlet to the outlet. When both the inlet and the outlet are positioned in the same housing section, just one of the housing sections ends up being tied into the flow line. This enables the other housing section to be removed to allow access for replacing the filter without having to disconnect either of the inlet or the outlet from a flow line.

Even more beneficial results may be obtained when the first housing section has a first peripheral flange and the second housing section has a second peripheral flange. This facilitates clamping the first housing section and the second housing section together. One form of clamping the first housing section and the second housing section together will be illustrated using a channel form band which wraps around the housing and clamps the first peripheral flange and the second peripheral flange together.

Even more beneficial results may be obtained when one of the first housing section or the second housing section has a sump. A mechanical conveyor may then be placed in communication with the sump whereby accumulated particulate matter unable to pass through the filter is removed from the housing by the mechanical conveyor. Means is provided to prevent loss of fluid pressure from the housing during operation of the mechanical conveyor, such that the mechanical conveyor is able to operate without disrupting fluid flow through the housing. Beneficial results have been obtained when the mechanical conveyor is an auger disposed in an auger tube which extends at an angle upwardly and outwardly from the sump. The length of the auger tube is selected to create a fluid head which prevents loss of fluid pressure from the housing during operation of the auger.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a first embodiment of filtration apparatus constructed in accordance with the teachings of the present invention.

FIG. 2 is an exploded perspective view of the filtration apparatus illustrated in FIG. 1.

FIG. 3 is a side elevation view, in section, of the filtration apparatus illustrated in FIG. 1.

FIG. 4 is an end elevation view, in section, of the filtration apparatus illustrated in FIG. 1.

FIG. 5 is a top plan view of a first housing section of the filtration apparatus illustrated in FIG. 1.

FIG. 6 is a perspective view of a second embodiment of filtration apparatus constructed in accordance with the teachings of the present invention.

FIG. 7 is a side elevation view, in section, of the filtration apparatus illustrated in FIG. 6.

### DETAILED DESCRIPTION OF THE PREFERRED EMBODIMENT

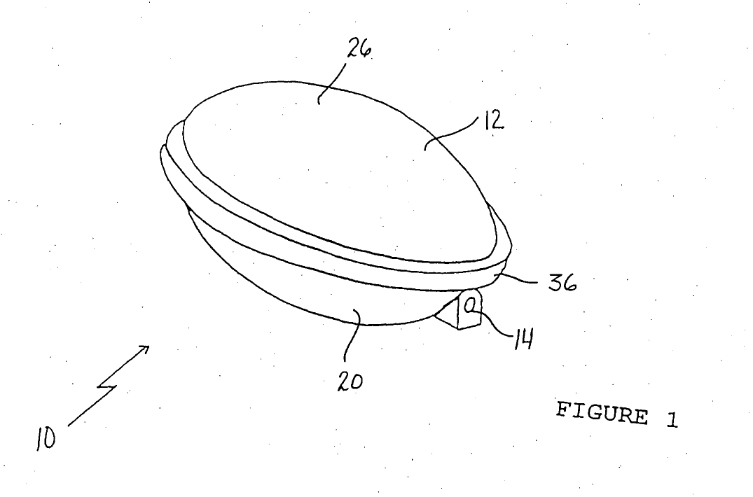

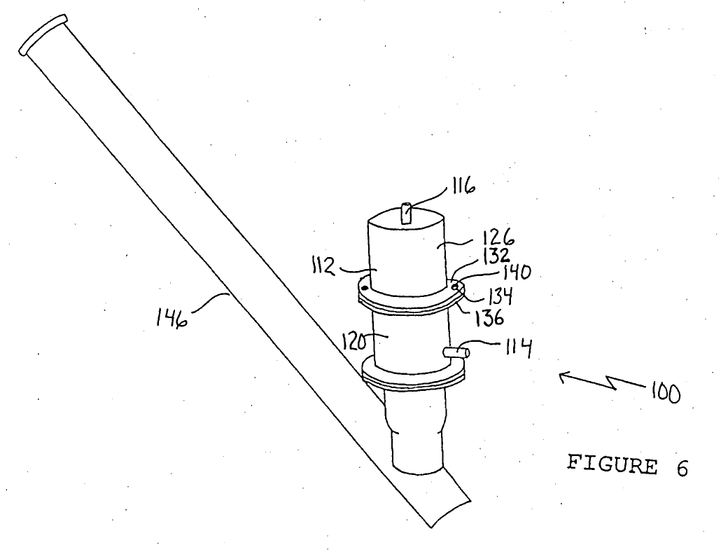

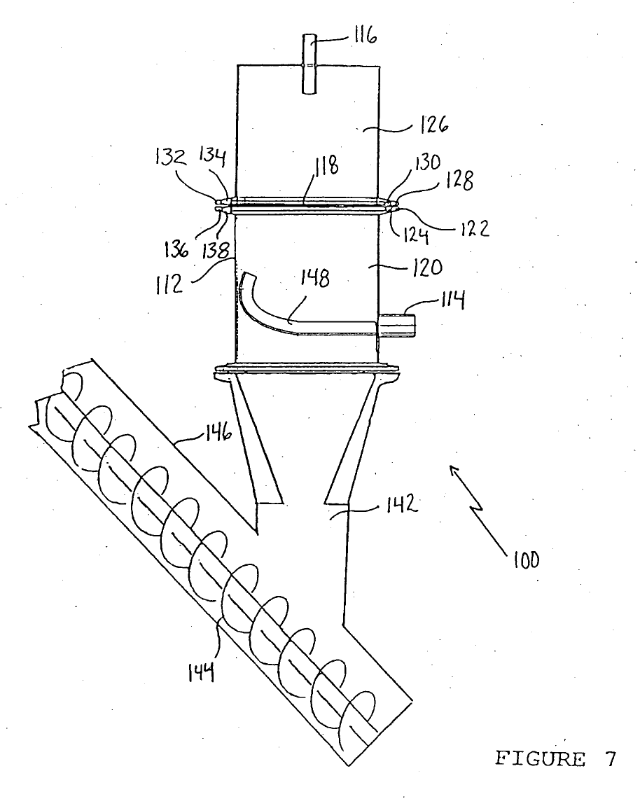

A first embodiment of filtration apparatus constructed in accordance with the teachings of the present invention and generally identified by reference numeral 10, will now be described with reference to FIGS. 1 through 5. A second embodiment of filtration apparatus constructed in accordance with the teachings of the present invention and generally identified by reference numeral 100, will now be described with reference to FIGS. 6 and 7.

Structure and Relationship of Parts for First Embodiment:

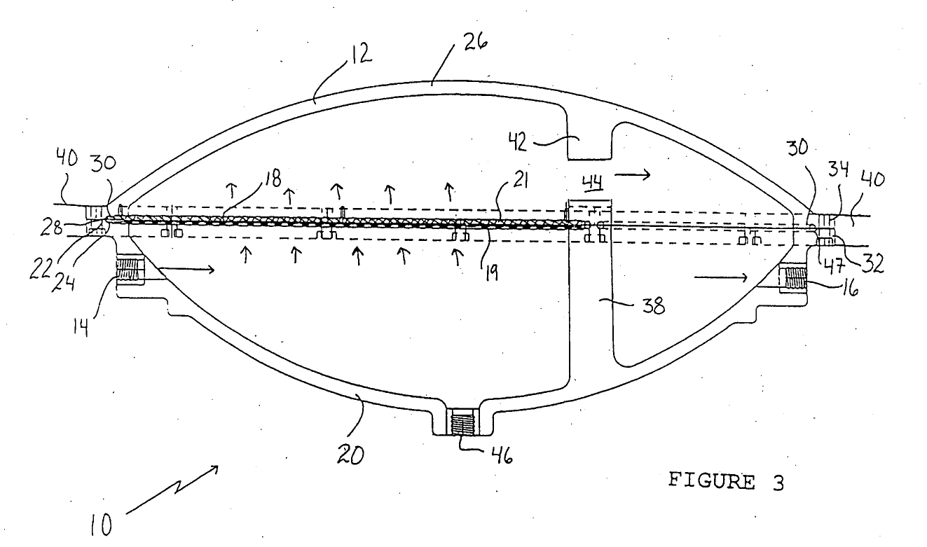

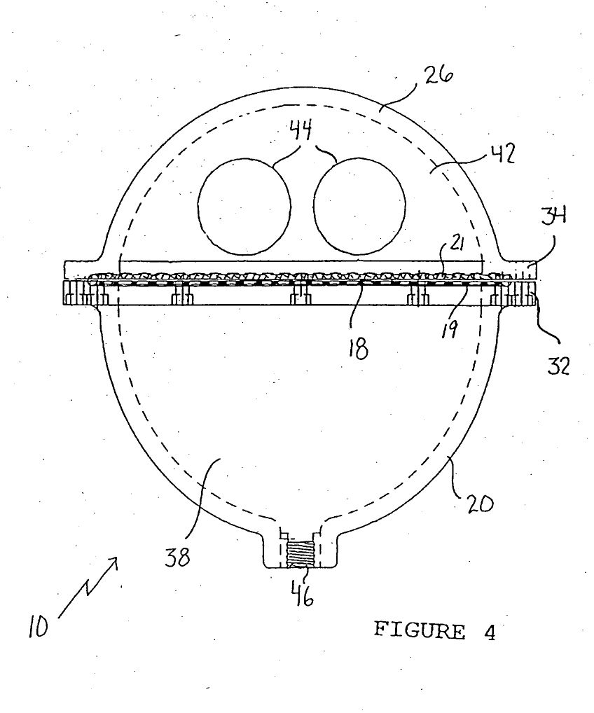

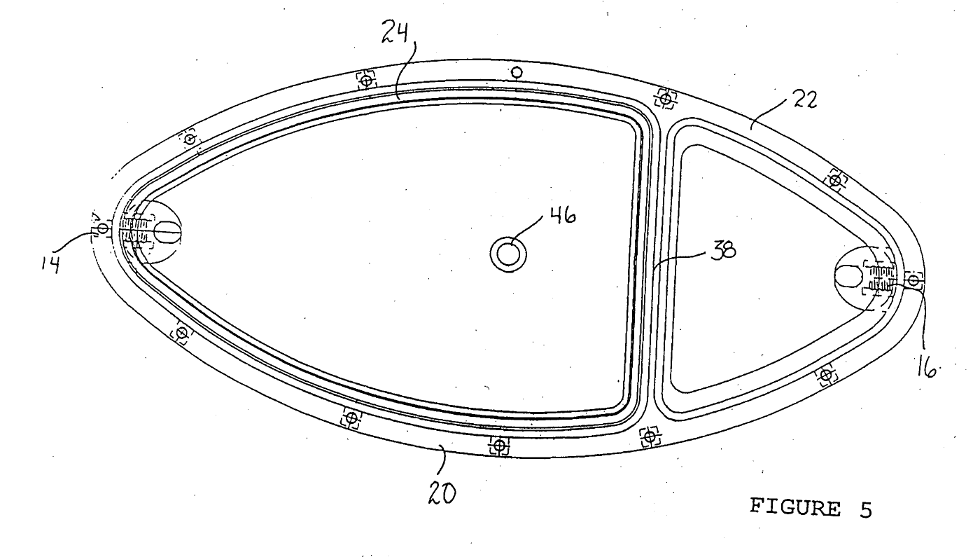

Referring to FIG. 1, filtration apparatus 10 includes a housing 12. Referring to FIG. 3, housing has an inlet 14, an outlet 16, and a filter 18 disposed between inlet 14 and outlet 16 so that fluids must flow through filter 18 in order to pass from inlet 14 to outlet 16. Referring to FIG. 5, filtration apparatus 10 has a first housing section 20 that has a first peripheral edge 22 with a filter retaining groove 24. Referring to FIG. 3, a second housing section 26 is provided that has a second peripheral edge 28 with a seal retaining groove 30. Referring to FIG. 4, first housing section 20 has a first peripheral flange 32 and second housing section 26 has a second peripheral flange 34. Referring to FIG. 3, in order to clamp first housing section 20 and second housing section 26 together, a channel form band 36 wraps around housing 12 and clamps first peripheral flange 32 and second peripheral flange 34 together. In the illustrated embodiment, channel form band 36 is illustrated as being in two portions although it will be appreciated that it could also be in a single continuous band. It will be appreciated that bolts could be used as an alternative means to further secure first housing 20 to second housing 26. Filter retaining groove 24 is adapted to retain a rigid planar filter 18 when first housing section 20 and second housing section 26 are clamped together. Rigid planar filter 18 consists of a perforate rigid planar filter support 19 covered by a membrane filter 21. This construction is preferred because it is less expensive to replace membrane filter 21 and reuse perforate rigid planar filter support 19.

Referring to FIGS. 3 and 5, inlet 14 and outlet 16 are both positioned in first housing section 20 with a baffle 38 positioned between inlet 14 and outlet 16 to prevent fluids from flowing directly from inlet 14 to outlet 16. When inlet 14 and outlet 16 are secured to a flow line 40, first housing section 20 becomes a fixed part of flow line 40. However, second housing section 26 can readily be removed to allow access for replacing filter 18 without having to disconnect either of inlet 14 or outlet 16 from a flow line 40. Referring to FIGS. 3 and 4, second housing section 26 has a flow through partition 42 which has apertures 44 that allow for the passage of fluid.

Referring to FIG. 3, a clean out opening 46 is also provided in first housing section 20. Clean out opening 46 allows for the removal from housing 12 of particulate matter that is unable to pass through filter 18.

Operation of First Embodiment:

The use and operation of first embodiment of filtration apparatus 10 will now be described with reference to FIGS. 1 through 5.

Referring to FIG. 3, fluids enter filtration apparatus 10 through inlet 14 in first housing section 20. As the fluid level rises, the fluids pass up through filter 18 into second housing section 26. After passing through filter 18 into second housing section 26, fluids flow through apertures 44 in partition 42 in second housing section 26 and then exit from filtration apparatus 10 through outlet 16 in first housing section 20. Any particulate matter that does not pass through filter 18 can subsequently be removed from housing 12 through clean out opening 46 in first housing section 20. It is preferred that a seal 47 be positioned in seal retaining groove 30, so that there is no leakage from between first housing section 20 and second housing section 26.

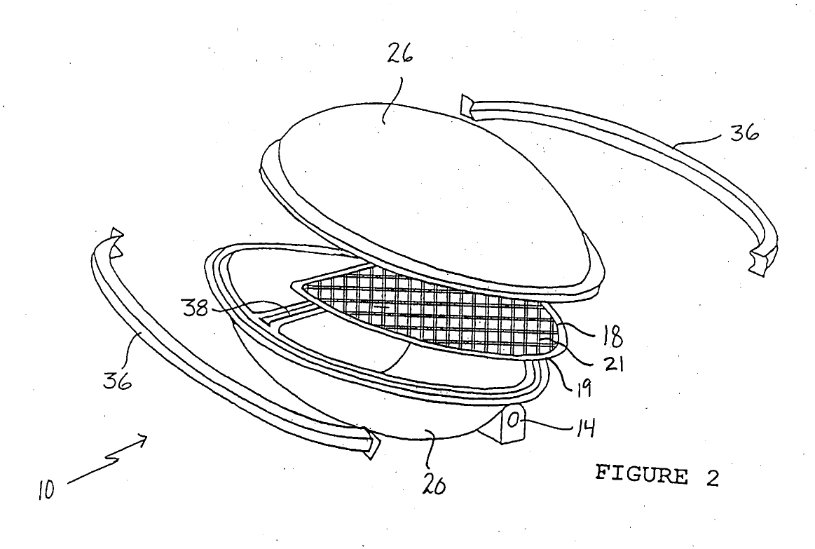

Referring to FIG. 2, in the event that filtration apparatus 10 requires servicing or replacement of filter 18, the flow of fluids into housing 12 can be temporarily shut off and second housing section 26 can be removed from first housing section 20 by removal of channel form band 36. As both inlet 14 and outlet 16 are positioned in first housing section 20, second housing section 26 can be removed to allow access for replacing filter 18 without having to disconnect either of inlet 14 or outlet 16 from flow line 40. The soiled filter 18 is removed from filter retaining groove 24. A new filter 18 can then be dropped into place. Where rigid planar filter 18 consists of perforate rigid planar filter support 19 covered by membrane filter 21, only membrane 21 need be replaced.

Structure and Relationship of Parts for Second Embodiment:

Referring to FIG. 7, filtration apparatus 100 includes a housing 112 having an inlet 114, an outlet 116, and a filter 118 disposed between inlet 114 and outlet 116 so that fluids must flow through filter 118 in order to pass from inlet 114 to outlet 116. Filtration apparatus 100 has a first housing section 120 that has a first peripheral edge 122 with a filter retaining groove 124. A second housing section 126 is provided that has a second peripheral edge 128 with a seal retaining groove 130.

First housing section 120 has a first peripheral flange 132 with a first bolt receiving opening 134. Second housing section 126 also has a second peripheral flange 136 with a second bolt receiving opening 138. Referring to FIG. 6, first housing section 120 and second housing section 126 are clamped together by placing first peripheral flange 132 and second peripheral flange 136 in face to face relation with first bolt receiving openings 134 aligned with second bolt receiving openings 138 and securing first peripheral flange 132 and second peripheral flange 136 together with bolts 140. Referring to FIG. 7, filter retaining groove 124 is adapted to retain rigid planar filter 118 when first housing section 120 and second housing section 126 are clamped together.

First housing section 120 has a sump 142. An auger 144 is disposed in an auger tube 146 which extends at an angle upwardly and outwardly from sump 142. The length of auger tube 146 is selected to create a fluid head which prevents loss of fluid pressure from housing 112 during operation of auger 144.

Operation of Second Embodiment:

The use and operation of second embodiment of filtration apparatus 100 will now be described with reference to FIGS. 6 to 7. Referring to FIG. 6, fluids enter filtration apparatus 100 through inlet 114 in first housing section 120. As the fluids continue to enter, they pass up through filter 118 and into second housing section 126. A fluid guide 148 extends from inlet 114 into first section 120 to direct incoming fluid up toward filter 118. After passing through filter 118 into second housing section 126, fluids exit from filtration apparatus 100 through outlet 116 in second housing section 126. Any particulate matter that does not pass through filter 118 tends to settle by gravity into sump 142, where is removed from housing 112 by auger 144 which carries the particulate matter up auger tube 146. Auger tube 146 is made long enough that a fluid head is created that enables filtration apparatus to continue operating without a significant loss of pressure while auger 144 is operating.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The embodiments of the invention in which an exclusive property or privilege is claimed are defined as follows:

1. A filtration apparatus which includes a housing having an inlet, an outlet, and a filter disposed between the inlet and the outlet so that fluids must flow through the filter in order to pass from the inlet to the outlet, characterized by:
a first housing section with first peripheral edge;
a second housing section with a second peripheral edge;
one of the first peripheral edge of the first housing section or the second peripheral edge of the second housing section having a filter retaining groove;
One of a rigid planar filter or a perforate rigid planar support adapted to support a filter membrane is disposed in the filter retaining groove; and
means for clamping the first housing section and the second housing section together.

2. The filtration apparatus as defined in claim 1, wherein a clean out opening is provided in one of the first housing section and the second housing section, whereby particulate matter unable to pass through the filter is removed from the housing.

3. The filtration apparatus as defined in claim 1, wherein the inlet and the outlet are both positioned in the first housing section with a baffle positioned between the inlet and the outlet to prevent fluids from flowing directly from the inlet to the outlet, thereby enabling the second housing section to be removed to allow access for replacing the filter without having to disconnect either of the inlet or the outlet from a flow line.

4. The filtration apparatus as defined in claim 1, wherein the first housing section has a first peripheral flange, the second housing section has a second peripheral flange and the means for clamping the first housing section and the second housing section together engages the first peripheral flange and the second peripheral flange.

5. The filtration apparatus as defined in claim 4, wherein a channel form band wraps around the housing and clamps the first peripheral flange and the second peripheral flange together.

6. The filtration apparatus as defined in claim 1, wherein one of the first housing section or the second housing section has a sump, a mechanical conveyor being in communication with the sump whereby accumulated particulate matter unable to pass through the filter is removed from the housing by the mechanical conveyor, means being provided to prevent loss of fluid pressure from the housing during operation of the mechanical conveyor, such that the mechanical conveyor is able to operate without disrupting fluid flow through the housing.

7. The filtration apparatus as defined in claim 6, wherein the mechanical conveyor is an auger disposed in an auger tube which extends at an angle upwardly and outwardly from the sump, the length of the auger tube being selected to create a fluid head which prevents loss of fluid pressure from the housing during operation of the auger.
